(19) United States
(12) Patent Application Publication
(10) Pub. No.: US 2023/0186224 A1
(43) Pub. Date: Jun. 15, 2023

(54) SYSTEMS AND METHODS FOR ANALYZING AND OPTIMIZING WORKER PERFORMANCE

(71) Applicant: Accenture Global Solutions Limited, Dublin (IE)

(72) Inventors: Lan Guan, New York, NY (US); Aiperi Iusupova, Chicago, IL (US); Purvika Bazari, Gurugram (IN); Neeraj D. Vadhan, Los Altos, CA (US); Madhusudhan Srivatsa Chakravarthi, Lisboa (PT); Lana Grimes, St. Catharines (CA); Jill Christine Gengelbach-Wylie, Austin, TX (US)

(21) Appl. No.: 17/549,414

(22) Filed: Dec. 13, 2021

(51) Int. Cl. G06Q 10/06; G06N 20/00

(52) U.S. Cl. CPC G06Q 10/06398; G06Q 10/0633; G06Q 10/063116; G06N 20/00

(57) ABSTRACT

The disclosed system and method focus on applying machine learning to monitor, analyze, and optimize operational procedures. A role-tailored user interaction with a dashboard that enables a user with multiplicity of views, including but not limited to operational data feeds, analytic and visualization feeds, supervisory, policy making, personnel management and other organizational capabilities is disclosed. The multiplicity of dashboard features relates to measurement and assessment of an organization's compliance with operational performance metrics, that are quantified based on real-time, near real-time data feeds, statistical and algorithmic models. The metrics on the dashboard may be presented in the role-tailored fashion with statistical view of the next best action and recommendations when analyzed metrics exceed safe limits. Alert and communication features may be implemented in the dashboard to promote timely response to suggested corrective actions across the organization.

### TECHNICAL FIELD

The present disclosure generally relates to operation center environments. More specifically, the present disclosure generally relates to systems and methods for analyzing performance of workers in operation center environments and for recommending corrective actions that can be taken to improve performance.

### BACKGROUND

Many operational business units need to maintain high standards of worker performance. However, it is difficult to monitor worker performance accurately and easily, and to determine how to counteract conditions negatively impacting performance. Monitoring worker performance and determining solutions to declines in performance can be particularly difficult in a geographically dispersed enterprise setting.

Accordingly, there is a need in the art for systems and methods for efficiently and effectively analyzing and optimizing worker performance.

### SUMMARY

The disclosed system and method provide an operational performance platform with a holistic approach to monitoring operational performance (e.g., operational metrics), as well as trends in operational performance (e.g., declines in performance) and recommending corrective actions that can counteract a decline in performance. It should be appreciated that simply gathering bits of data related to worker performance is not enough to gain the insights needed to see the full picture of worker performance in an operational system. Traditional solutions fail to provide a comprehensive approach to standardizing large amounts of digital operational data from many disparate sources to make analysis of the data more accurate. Traditional solutions do not collect, process, and utilize data to display accurate metrics of operational performance and to generate recommendations for corrective actions to counteract declines in performance. Rather, traditional solutions rely on human resources or limited piecemeal approaches, which do not accurately capture precise operational metrics and do not accurately determine the connection between certain operational procedures or other factors and the operational metrics.

The disclosed system and method provide a way to aggregate, process, and/or store, a large amount of data from various, disparate sources in an intelligent data foundation in a secure manner. For example, these sources may include computing devices used by workers under analysis. Additionally, the large amount of data from various, disparate sources may be aggregated and processed by intelligent data foundation to generate standardized performance metrics. These standardized performance metrics may enable downstream components of the system (e.g., root cause analysis engines) to perform accurate root cause analysis of performance and trends in performance (e.g., a decline in performance). Furthermore, these standardized performance metrics, as well as recommended solutions, may be provided to users by a dashboard that quickly conveys this information in real-time or near real-time to provide an easily digestible, comprehensive visualization of performance trends. The dashboard also provides a way for the user to drill down into finer details of performance trends and factors contributing to performance trends. Such numerous and detailed factors and relationships between factors and performance would not be possible by a manual system. By processing input data into standardized performance metrics and providing artificial intelligence based root cause analysis, artificial intelligence based predictions of future operational performance (based on input of current digital operational data, e.g., pertaining to staffing schedule or operational metrics trends), and recommended corrective actions for counteracting current or predicted future declines in operational performance, the present system and method provides a comprehensive understanding of the operational performance of a workforce. With these features, the present system and method is faster and less error prone than traditional solutions, thus providing an improvement in the field of analyzing digital operational data and integrating the system and method into the practical application of applying machine learning to monitor, analyze, and optimize operational procedures.

In one aspect, the disclosure provides a computer implemented method for applying machine learning to monitor, analyze, and optimize operational procedures. The method may include aggregating operational data from data sources, wherein the operational data includes at least operational performance data. The method may include training a machine learning model to analyze the operational data to identify a decline in operational performance, map performance related factors to the decline in operational performance, and determine a corrective action corresponding to the decline in operational performance. The method may include applying the machine learning model to analyze the operational data to identify a decline in operational performance, map performance related factors to the decline in operational performance, and determine a corrective action for counteracting the decline in operational performance. The method may include presenting, through a graphical user interface, an output comprising the operational performance data, the time period corresponding to the operational performance data, the mapped performance related factors, and the corrective action.

In some embodiments, aggregating operational data may include aggregating the operational data into an intelligent data foundation. In some embodiments, the method may further include processing the aggregated operational data through the intelligent data foundation to generate standardized performance metrics, wherein applying the machine learning model to analyze the operational data includes analyzing the standardized performance metrics. In some embodiments, the standardized performance metrics may include one or more of efficiency, effectiveness, and handling time. In some embodiments, the factors may include organizational processes. In some embodiments, the corrective action may include one or both of spending more time on training workers to improve efficiency and adjusting the schedule of workers to have a higher balance of tenured employees on duty during specific shifts. In some embodiments, the method may further include receiving from a user through the graphical user interface input requesting display of performance related subfactors and using the input to update the graphical user interface to simultaneously display mapped performance related factors with performance related subfactors.

In some embodiments, the training may include supervised training. In some embodiments, the training may include unsupervised training. In some embodiments, the operational performance data may include performance metrics including one or more of efficiency, effectiveness, and handling time. In some embodiments, the factors may include organizational processes. In some embodiments, the corrective action may include one or both of spending more time on training workers to improve efficiency and adjusting the schedule of workers to have a higher balance of tenured employees on duty during specific shifts. In some embodiments, aggregating operational data may include aggregating the operational data into an intelligent data foundation.

In another aspect, the disclosure provides a system for applying machine learning and active learning to monitor, analyze, and optimize operational procedures. The system may comprise one or more computers to continuously learn from actual model prediction and one or more storage devices storing instructions that are operable, when executed by the one or more computers, to cause the one or more computers to perform the above-mentioned methods.

In yet another aspect, the disclosure provides a non-transitory computer-readable medium storing software comprising instructions executable by one or more computers which, upon such execution, cause the one or more computers to perform the above-mentioned methods.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 shows a schematic diagram of a system for analyzing and optimizing worker performance, according to an embodiment.

FIG. 2 shows a flow of information from components of the system, according to an embodiment.

FIG. 3 shows a schematic diagram of details of the operational analytic record, according to an embodiment.

FIG. 4 shows a schematic diagram of details of the enterprise analytic record, according to an embodiment.

FIG. 5 shows a schematic diagram of details of the operational intelligence engine, according to an embodiment.

FIG. 6 shows a schematic diagram of details of the data processing module, data modeling module, and data advisory module, according to an embodiment.

FIG. 7 shows a schematic diagram of details of the operational efficiency root cause analysis engine, according to an embodiment.

FIG. 8 shows a schematic diagram of details of the operational effectiveness root cause analysis engine, according to an embodiment.

FIG. 9 shows a flowchart of a computer implemented method of analyzing and optimizing worker performance, according to an embodiment.

FIG. 10 shows a flowchart of a computer implemented method of analyzing and optimizing worker performance, according to an embodiment

FIGS. 11-13 show screenshots of components of a dashboard on a graphical user interface, according to an embodiment.

FIGS. 14-15 show screenshots of components of a dashboard on a graphical user interface, according to an embodiment.

FIG. 16 show screenshots of components of a dashboard on a graphical user interface, according to an embodiment.

FIGS. 17-21 show screenshots of components of a dashboard on a graphical user interface, according to an embodiment.

FIG. 22 shows a table listing factors and subfactors for an organizational updates group, according to an embodiment.

FIG. 23 shows a table listing factors and subfactors for a performance group, according to an embodiment.

FIG. 24 shows a behavior formula, according to an embodiment.

FIG. 25 shows an effectiveness formula, according to an embodiment.

FIG. 26 shows an efficiency formula, according to an embodiment.

### DESCRIPTION OF EMBODIMENTS

Many operational business units are growing dependent on managing and tracking operational excellence metrics to maintain high standards of performance. The importance of operational excellence metrics, an organization's ability to maintain optimal working conditions. In such working conditions, organizations can benefit from monitoring worker's performance and assessing their operational fitness to handle job of varying nature. The key to building resilient performance and quantifying workforce readiness to handle rapid changes and dynamic job demands lies within continual assessment and analysis of operational excellence.

Systems and methods described in this disclosure can be implemented in many work environments to optimize business performance and service delivery. The examples of operation centers involve units conducting communications, media, banking, consumer goods, retail, travel, utilities, insurance, healthcare, police departments, emergency departments, and other services. The example use cases are configured for (but not limited to) content moderation, community management, advertiser review, copyright infringement, branding and marketing, financial and economic assessment, and other operations. In some embodiments, the disclosed system and method may be integrated with the systems and methods described in U.S. Pat. No. 11,093,568, issued to Guan et al. on Aug. 17, 2021 and U.S. Patent Application Publication Number 2021/0042767, published on Feb. 11, 2021, which are hereby incorporated by reference in their entirety.

Systems and methods are disclosed to embody operational excellence dashboard used for monitoring and optimizing operation center and individual worker performance. The system enables a user to reciprocate with worker performance data elements to maintain and improve a balance between worker and organizational efficiency, effectiveness, and other performance metrics. The system performs this action by obtaining operational data feeds and determines a worker's and/or organization's operational excellence dashboard using algorithmic modeling engines. The system also enables a user to view and track resilience scores at worker and organizational levels, in general, to optimize working conditions.

The present disclosure provides systems and methods that monitor, on a real-time/near real-time basis, a worker's behavior as reflected on both worker's performance report and modeling output, identifies areas of skill development, proactively alerts of policy and process updates, recommends corrective actions that can improve worker's and/or organization's operational excellence dashboard, and identifies the right time for workers to take corrective actions, including, but not limited to spending more time on training to improve efficiency, adjusting the schedule of workers to have a higher balance of tenured employees on duty during specific shifts, and/or seeking wellness support to improve their coping skills in handling work under dynamic conditions. Thus, the innovation provides systems and methods that assist in the implementation of recommended corrective actions on behalf of a worker and/or organization.

The disclosure is presented as an operational performance dashboard and reporting tool, and more specifically as a role-based organizational platform with a set of statistical and machine learning modeling engines used for monitoring and optimizing performance of individual workers and operation centers in general. The modeling engine may produce at least one metric and at least one dashboard, each configured to track performance and measure progress towards operational strategic targets. The metric and the dashboard may be updated on the real-time/near real-time basis, depending on the multiplicity of data inputs. The data inputs may be irrespective and/or correlated with each other for generating measures that objectively gauge the degree of performance change over time. The data inputs and modeling engine are responsible for establishing metrics displayed on the dashboard and made available to the end users.

Using the disclosed dynamic operational excellence dashboard system, decision makers can strategically plan and manage operation centers to communicate overarching goals they are trying to accomplish, align with employees' day-to-day productivity, prioritize content and other deliverables, and measure and monitor worker and operation center efficacy. The implementation of systems and methods of this disclosure are focused on the achievement of balanced operational excellence dashboard using various performance metrics such as efficiency, effectiveness, and others. Although, these indicators form the basis of our proposed operational excellence dashboard, other relevant measures might be used in the dashboard.

Thus, the dashboard may also serve as a collaboration tool with real-time alerts to facilitate communication between workers and supervisors for continuous performance improvements and timely interventions. The communication and alert-based system enables supervisors and decision makers to share policy and/or process updates and intervene with worker's day to day operations. The role-based dashboard, ensuring workers and supervisors with real-time reports on operational excellence performance metrics, data and modeling feeds, and collaboration functions to support efficient and reliable decision making, is the ultimate artifice and embodiment of the disclosed solution.

Systems and methods in this disclosure address industry need to monitor and track when operational metrics exceed ideal limits of working conditions and facilitate timely communication between workers and supervisors across entire organization. Driving workforce performance and operational excellence with an intelligent data foundation and embedded advanced analytics throughout an organization is a goal of the innovation. A role-tailored dashboard with operational metrics such as efficiency and effectiveness, have been proposed to improve organizational performance. Systems and methods have been configured to proactively monitor risk factors to detect and help at-risk workers, facilitate standardized metrics to enable accurate root cause analysis of deteriorated performance, and inform leadership and supervisory of potential operational improvements to balance workload and maintain high standards of performance.

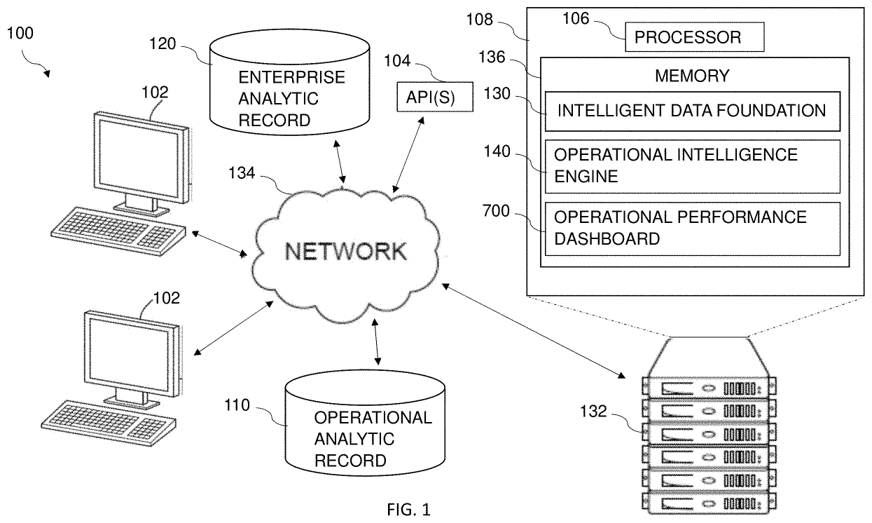

FIG. 1 shows a schematic diagram of a system for analyzing and optimizing worker performance 100 (or system 100), according to an embodiment. The disclosed system may include a plurality of components capable of performing the disclosed method (e.g., method 900). For example, system 100 may include one or more activity devices 102, one or more application programming interface(s) (API(s)) 104, an operational analytic record 110, an enterprise analytic record 120, a computing system 132, and a network 134. The components of system 100 can communicate with each other through a network 134. For example, API(s) 104 may retrieve information from activity device 102 via network 134. In some embodiments, network 134 may be a wide area network (“WAN”), e.g., the Internet. In other embodiments, network 134 may be a local area network (“LAN”).

While FIG. 1 shows two activity devices, it is understood that one or more user devices may be used. For example, in some embodiments, the system may include three user devices. In another example, in some embodiments, 10,000 user devices may be used. The activity devices may be used for inputting, processing, and displaying information. The activity device(s) may include user device(s) on which workers in a workforce perform their duties. In some embodiments, the user device(s) may be computing device(s). For example, the user device(s) may include a smartphone or a tablet computer. In other examples, the user device(s) may include a laptop computer, a desktop computer, and/or another type of computing device. The user device(s) may be used for inputting, processing, and displaying information and may communicate with API(s) through a network.

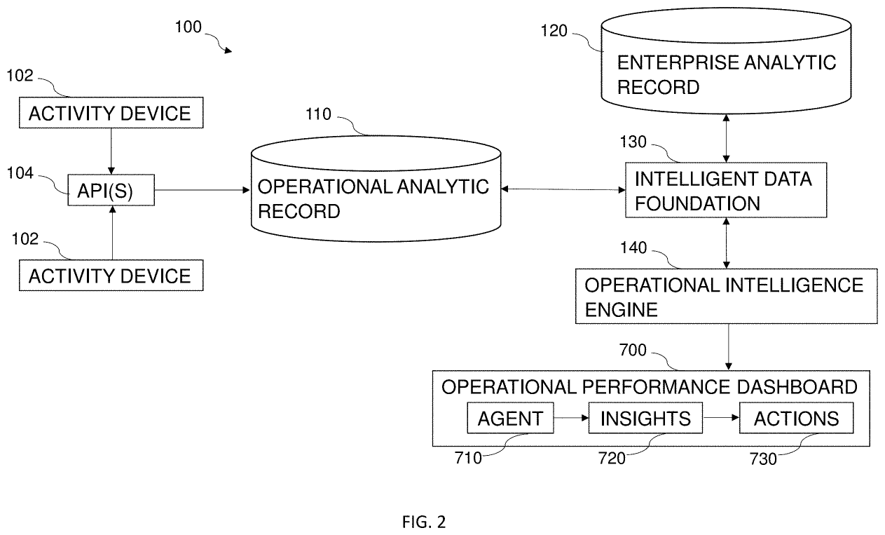

As shown in FIG. 2, in some embodiments, an intelligent data foundation 130, an operational intelligence engine 140, and an operational performance excellence dashboard 700 may be hosted in computing system 132. Computing system 132 may include a processor 106 and a memory 136. Processor 106 may include a single device processor located on a single device, or it may include multiple device processors located on one or more physical devices. Memory 136 may include any type of storage, which may be physically located on one physical device, or on multiple physical devices. In some cases, computing system 132 may comprise one or more servers that are used to host intelligent data foundation 130, operational intelligence engine 140, and operational performance excellence dashboard 700.

FIG. 2 shows a flow of information from components of the system, according to an embodiment. During operation, one or more activity devices can communicate with APIs, which are software intermediaries that allow applications to communicate with each other, to contribute data to operational analytic record 110. The data describing activities occurring on activity devices may be automatically collected in a continuous fashion or at intervals. This data may be received, via the API(s), by operational analytic record 110.

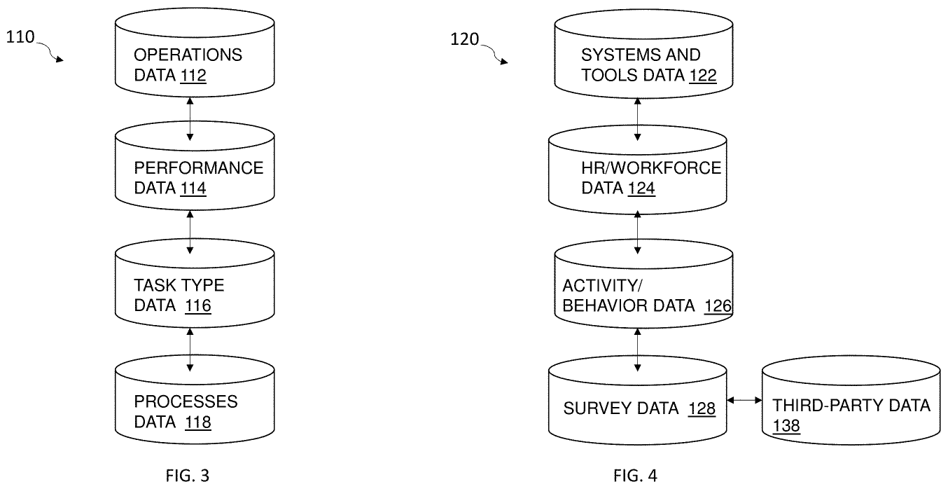

In some embodiments, operational analytic record 110 may contain multiple databases each dedicated to storing data related to particular categories. For example, as shown in FIG. 3, operational analytic record 110 may contain databases storing operations data 112, performance data 114, task type data 116, and/or processes data 118. In some embodiments, operations data may include, for example, the level of tenure of workers. Performance data may include metrics that can be used to measure progress towards operational strategic targets. In some embodiments, performance metrics may include efficiency, effectiveness, and others. For example, in some embodiments, these metrics may include handling time (e.g., time spent on each task or transaction). In some embodiments, such as embodiments where workers are content moderators, the task type data may include the category (e.g., bullying or violence) of content the workers are moderating. In other embodiments, such as those in which workers are nurses, task type data may include the category of health services (e.g., medication administration or reading vital signs) the nurses are performing. In some embodiments, processes data may include the different organizational processes the workforce follows. For example, organizational processes that might affect the performance of the operations may include scheduling, staffing, and certain policies that may be issued in order.

In some embodiments, as shown in FIG. 4, enterprise analytic record 120 may include data related to an enterprise employing the workers (or workforce) or associated with the workers. For example, enterprise analytic record 120 may include systems and tools data 122, HR/workforce data 124, activity/behavior data 126, survey data 128, and third party data 138.

The data from operational analytic record 110 may be input into intelligent data foundation 130 as raw data and operational analytic record 110 may reciprocally receive data from intelligent data foundation 130, including but not limited to information output from the various root cause engines discussed below. Similarly, enterprise analytic record 120 may be input into intelligent data foundation 130 as raw data and may reciprocally receive data from intelligent data foundation 130, including but not limited to information output from the various root cause engines discussed below. In this way, a large amount of data from various, disparate sources may be aggregated, processed, and/or stored in intelligent data foundation 130 in a secure manner. Additionally, in this way, the large amount of data from various, disparate sources may be aggregated and processed by intelligent data foundation 130 to generate standardized performance metrics. These standardized performance metrics may enable downstream components of the system (e.g., root cause analysis engines) to perform accurate root cause analysis of performance and trends in performance (e.g., a decline in performance).

In some embodiments, the intelligent data foundation may include a data engineering system comprising artificial intelligence and machine learning tools that can analyze and transform massive datasets in a raw format to intelligent data insights in a secure manner. Intelligent data foundation 130 may process the raw data from operational analytic record 110 and enterprise analytic record 120 into standardized metrics and may share the standardized metrics with operational intelligence engine 140.

The present embodiments may process the aggregated data stored in the intelligent data foundation 130 through a broad spectrum of artificial intelligence (AI) models on a real-time basis, to score, rank, filter, classify, cluster, identify, classify, and summarize data feeds. These AI models may be included in operational intelligence engine 140. These AI models may span supervised, semi-supervised, and unsupervised learning. The models may extensively use neural networks, ranging from convolutional neural networks to recurrent neural networks, including long short-term memory networks. Humans again cannot process such volumes of information and, more importantly, cannot prioritize the data, so that the most relevant data is presented first.

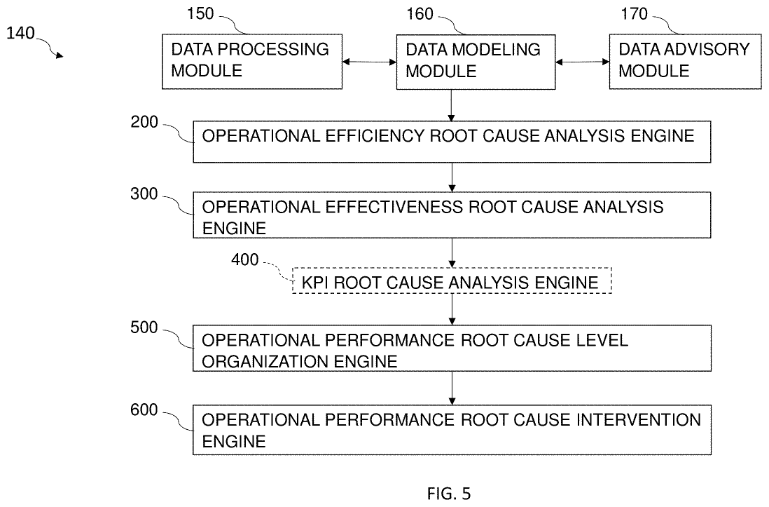

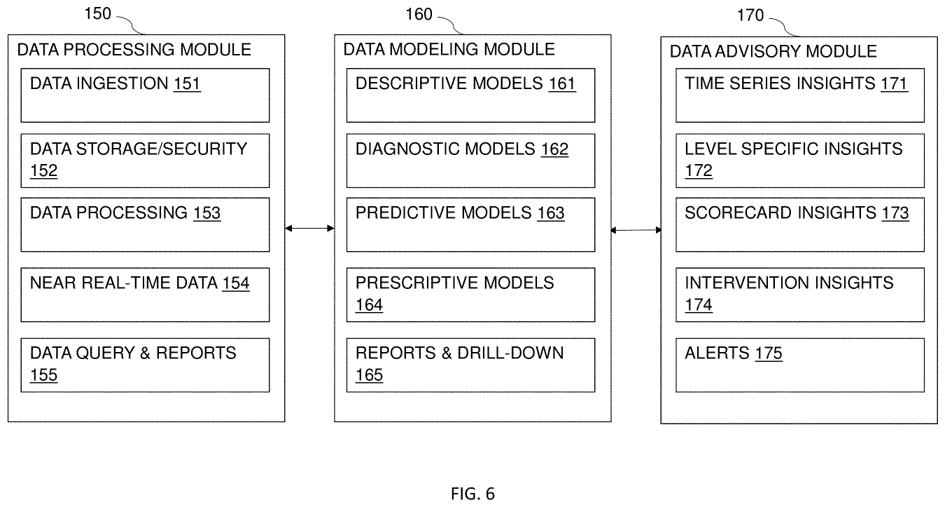

FIG. 5 shows a schematic diagram of details of the operational intelligence engine, according to an embodiment. Operational intelligence engine 140 may include a data processing module 150, a data modeling module 160, and a data advisory module 170. FIG. 6 shows a schematic diagram of details of the data processing module, data modeling module, and data advisory module, according to an embodiment.

In some embodiments, data processing module 150 may process data provided by intelligent data foundation into a format that is suitable for processing by downstream engines (e.g., operational efficiency root cause analysis engine 200). In some embodiments, data processing module 150 may include data ingestion 151, data storage/security 152, data processing 153, near real-time data 154, and data query and reports 155.

Data modeling module 160 may be a machine-learning and natural-language processing classification tool that is used for identifying distinct semantic structures and categories occurring within data sources. In some embodiments, data modeling module 160 may include data models related to business operations and associated metrics. In some embodiments, data modeling module 160 may establish metrics displayed on the dashboard and made available to the end users. Data modeling module 160 may include descriptive models 161, diagnostic models 162, predictive models 163, prescriptive models 164, and reports and drill-down 165.

Data advisory module 170 may include various insights based on results of processing data through the data modeling module. For example, in some embodiments, data advisory module 170 may include time series insights 171, level specific insights 172, scorecard insights 173, and alerts 175.

Operational intelligence engine 140 may further include multiple operational root cause analysis engines downstream from intelligent data foundation 130. For example, in the embodiment shown in the FIGS., the multiple operational root cause analysis engines may include an operational efficiency root cause analysis engine 200, an operational effectiveness root cause analysis engine 300, and an optional operational key performance indicator (KPI) root cause analysis engine 400.

A mixed-effect multivariate time series trend equation may include three components added together to yield lnYᵢ. The components may include a historical trend, an elasticity of impact levers, and random environmental shocks. The historical trend component may include the following equation:

ln yᵢ=φ₁ ln Yₜ₋₁+ . . . +φₜ ln Yₜβ₀ (Equation 1)

The elasticity of impact levers component may include the following equation:

Σₜ₌₁ⁿβt[ln(X_{k,j})−φ1 ln(X_{k,j-1})− . . . −φₙ ln(X_{k,j-t})] (Equation 2)

The random environmental shocks component may include the following equation:

εᵢ−θ₁εₜ₋₁− . . . −θ_{w}ε_{t-w} (Equation 3)

The multiple operational root cause analysis engines may apply machine learning to calculate factors (e.g., operational or performance related factors) as output coefficients that can be leveraged to reveal insights and that can be scaled to meet various scenarios.

Mixed-effect multivariate time series trend coefficients may include the following:

[y]=[a1]+[w1][y1(t−1)]+ . . . +[wp][y1(t−p)]+[e] (Equation 4)

Table 1 shows a unique factor coefficients corresponding to effectiveness factors according to an embodiment.

TABLE 1

| | w1 . . . wp(UNIQUE |
|---|---|
| EFFECTIVENESS FACTORS | FACTOR COEFFICIENTS) |
| Work Handling Factors | 1.690 |
| Organizational Change Factors | 1.865 |
| Competency and Tenure Factor | 2.041 |
| Performance Factors | 2.216 |
| Operational Factors | 0.988 |
| Activity/Behavioral Factors | 1.163 |
| Scheduling/Staffing Factors | 1.339 |
| Other Environmental Factors | 1.514 |

The root cause analysis engines may include machine learning models that receive the data in operational intelligence engine 140 as input to calculate and determine various features of the operational system/organization under analysis as output. The various features may include, for example, factors corresponding to performance metrics, relationships between factors and performance, predictions related to future performance, corrective actions that can improve performance, and/or relationships between corrective actions and performance.

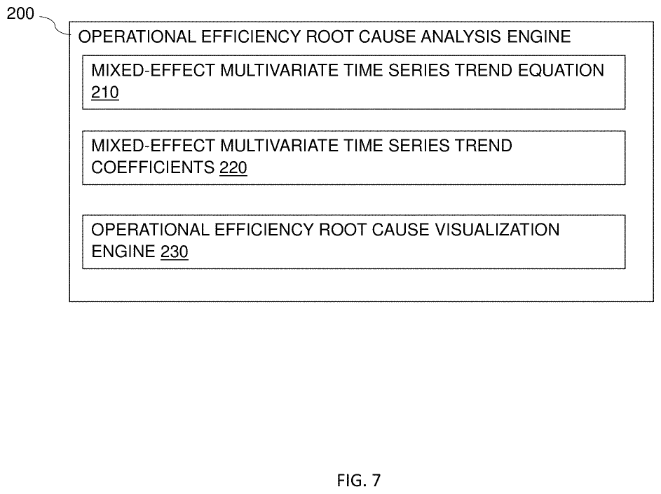

FIG. 7 shows a schematic diagram of details of the operational efficiency root cause analysis engine, according to an embodiment. Operational efficiency root cause analysis engine 200 may apply machine learning techniques to process data from intelligent data foundation 130 to determine which factors impact efficiency.

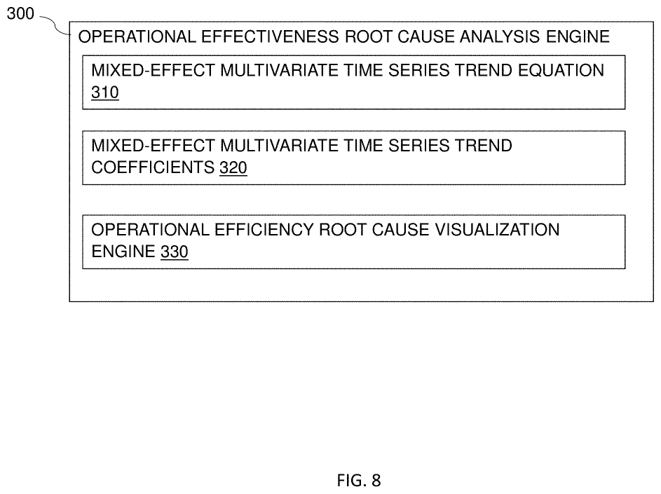

FIG. 8 shows a schematic diagram of details of the operational effectiveness root cause analysis engine, according to an embodiment. Operational effectiveness root cause analysis engine 300 may apply machine learning techniques to process data from intelligent data foundation 130 to determine which factors impact effectiveness.

Operational KPI root cause analysis engine 400 may apply machine learning techniques to process data from intelligent data foundation 130 to determine which factors impact certain predefined KPIs. For example, in some embodiments, the KPIs may include average handling time (AHT), quality, decision consistency, and/or reason consistency. In such cases, the operational KPI root cause analysis engine may include an AHT root cause analysis engine, a decision consistency root cause analysis engine, and a reason consistency root cause analysis engine.

Operational intelligence engine 140 may further include an operational performance root cause level organization engine 500 and an operational performance root cause intervention engine 600 downstream from intelligent data foundation 130. Operational intelligence engine 140 may further include an operational performance excellence dashboard 700, upon which an agent 710 may access insights 720 and suggested corrective actions 730.

Operational performance root cause level organization engine 500 may apply machine learning techniques to process data from intelligent data foundation 130 and/or output from other root cause analysis engines to organize groups within the workforce into levels indicating where the groups stand with respect to each other in terms of performance metrics. The levels may be based on whether the performance metrics are “above region” and “below region” meaning that the performance metrics are higher than average for the region or lower than average for the region, respectively.

As discussed above, operational performance root cause level organization engine 500 may organize groups within the workforce into levels indicating where the groups stand with respect to each other in terms of performance metrics. In some embodiments, the levels may be based on whether the performance metrics are “above region” and “below region.” The operational performance display may display levels (e.g., percentiles, tiers, etc.) and/or may display worker (e.g., agent) performance with respect to the region (e.g., other agents or groups of agents).

Operational performance root cause intervention engine 600 may apply machine learning techniques to process data from intelligent data foundation 130 and/or output from other root cause analysis engines to determine which corrective action(s) can counteract a decline in performance. The corrective action(s) may be determined based upon the root causes identified by the root cause analysis engine(s).

As the system monitors performance metrics, the root cause analysis engine(s) can pinpoint specific factors that are the drivers of the operational performance. Accordingly, if a decline in performance and/or efficiency and/or effectiveness is identified by the operational intelligence engine (e.g., displayed by the dashboard), the root cause analysis engine(s) can pinpoint specific factors that are the drivers of the operational performance. The operational performance root cause intervention engine can match a corrective action to the root cause identified by the root cause analysis engine(s). In other words, the corrective action may be a change in the organizational processes that might improve the operational performance. In addition to identifying an actual decline in operational performance, the operational intelligence engine can predict future declines in operational performance based on an analysis of observed trends in operational performance or in root causes. The cause intervention engine can match a corrective action to the predicted performance decline to prevent a decline in operational performance. For example, if the operational intelligence engine recognizes that tenured workers will not be schedule the next day, the system can proactively provide this insight and recommend rearranging the schedule to include more tenured workers for the next day.

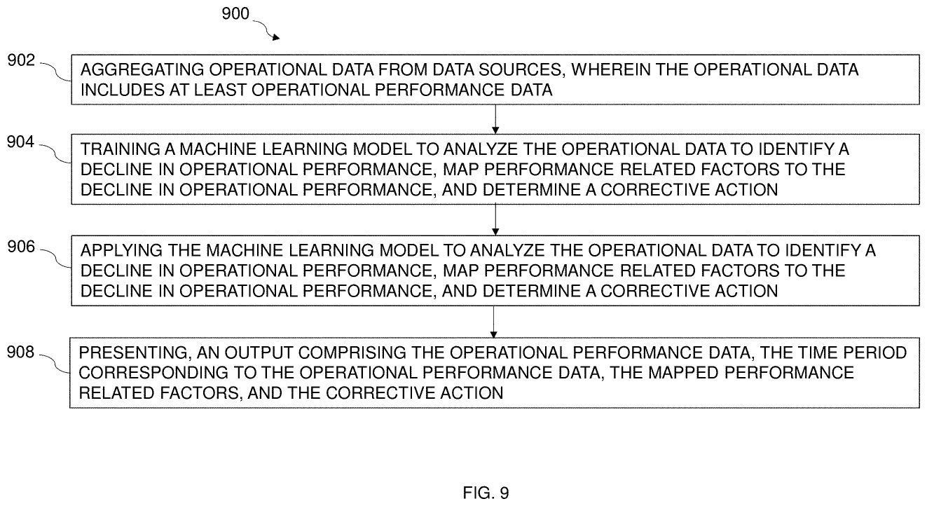

FIG. 9 shows a computer implemented method for applying machine learning to monitor, analyze, and optimize operational procedures 900 (or method 900), according to an embodiment. Method 900 may include aggregating operational data from data sources, wherein the operational data includes at least operational performance data (operation 902). Method 900 may include training a machine learning model to analyze the operational data to identify a decline in operational performance, map performance related factors to the decline in operational performance, and determine a corrective action corresponding to the decline in operational performance (operation 904). Method 900 may include applying the machine learning model to analyze the operational data to identify a decline in operational performance, map performance related factors to the decline in operational performance, and determine a corrective action for counteracting the decline in operational performance (operation 906). Method 900 may include presenting, through a graphical user interface, an output comprising the operational performance data, the time period corresponding to the operational performance data, the mapped performance related factors, and the corrective action (operation 908).

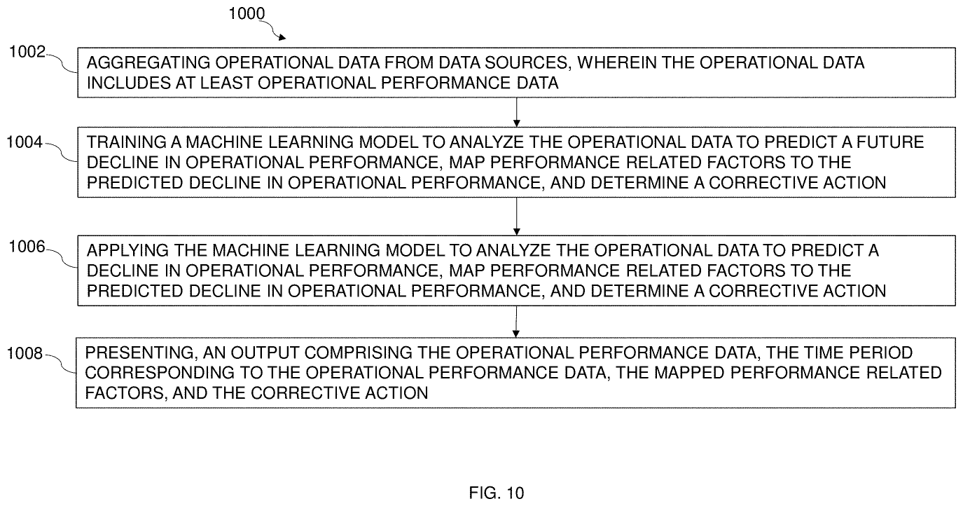

FIG. 10 shows a computer implemented method for applying machine learning to monitor, analyze, and optimize operational procedures 1000 (or method 1000), according to an embodiment. Method 1000 may include aggregating operational data from data sources, wherein the operational data includes at least operational performance data (operation 1002). Method 1000 may include training a machine learning model to analyze the operational data to predict a future decline in operational performance, map performance related factors to the predicted decline in operational performance, and determine a corrective action corresponding to the predicted decline in operational performance (operation 1004). Method 1000 may include applying the machine learning model to analyze the operational data to predict a future decline in operational performance, map performance related factors to the predicted decline in operational performance, and determine a corrective action for counteracting the precited decline in operational performance (operation 1006). Method 1000 may include presenting, through a graphical user interface, an output comprising the operational performance data, the time period corresponding to the operational performance data, the mapped performance related factors, and the corrective action (operation 1008).

In some embodiments, the training may include supervised training. In some embodiments, the training may include unsupervised training. In some embodiments, the operational performance data may include performance metrics including one or more of efficiency, effectiveness, and handling time. In some embodiments, the factors may include organizational processes. In some embodiments, the corrective action may include one or both of spending more time on training workers to improve efficiency and adjusting the schedule of workers to have a higher balance of tenured employees on duty during specific shifts. In some embodiments, aggregating operational data may include aggregating the operational data into an intelligent data foundation.

In some embodiments, approximately 300 to 400 factors may be considered/analyzed by the machine learning model, but just for clarity purposes the factors may be grouped into broader buckets in the insights provided by the dashboard on a graphical user interface. The broader buckets may also be used to simplify calculations by using aggregated factors in fewer calculations rather than performing many calculations each based on a different individual factor. In this way, fewer computing resources are used, and higher efficiency is achieved. The user may be given the option to drill down into each of these buckets to have further granular views on the subfactors impacting KPIs. For example, in an embodiment in which content moderation is the operation under analysis, an operational performance display may display, for a selected duration (e.g., from August 2021 through September 2021), operational performance, events, shift, staffing, tenure/training, policy updates, volume mix, AHT (in seconds), AHT slope, and factor contribution slopes. By showing a graphical representation of these various characteristics, one can see how these characteristics compare with one another at different points in time. Some of these characteristics are factors determined by an AHT root cause analysis engine as impacting AHT. For example, these factors may include events, shift, staffing, tenure/training, policy updates, and/or volume mix. If the user seeking insight and guidance from the dashboard wishes to see a more granular level of characteristics, the user may view a drill-down analysis visualization that displays subfactors with their contribution percentage on the same screen as the broader characteristics mentioned above. For example, the subfactors impacting AHT and shown on a drill-down analysis visualization may include decision touch, support compromise, specific tenure levels (e.g., 46-48 months, 12-24 months, less than 3 months, etc.), recall, review decision accuracy, review reason accuracy, backlog, utilization percentage, morning shift percentage, content reactive touch, positive even, precision, evening shift percentage, and/or job training.

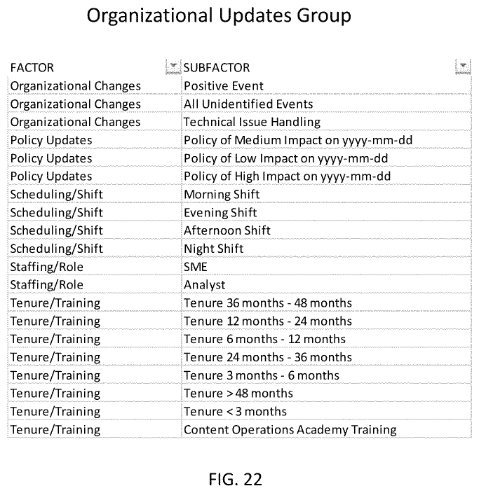

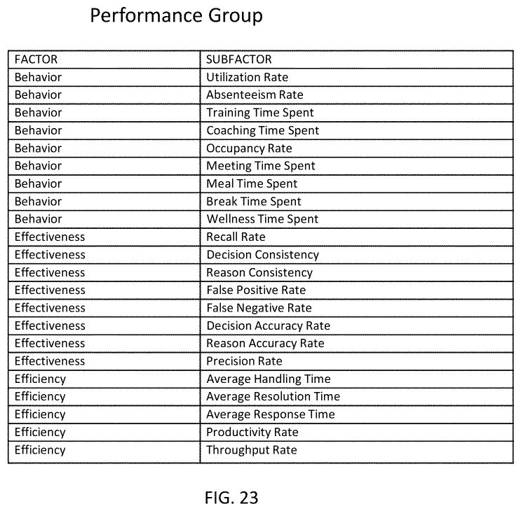

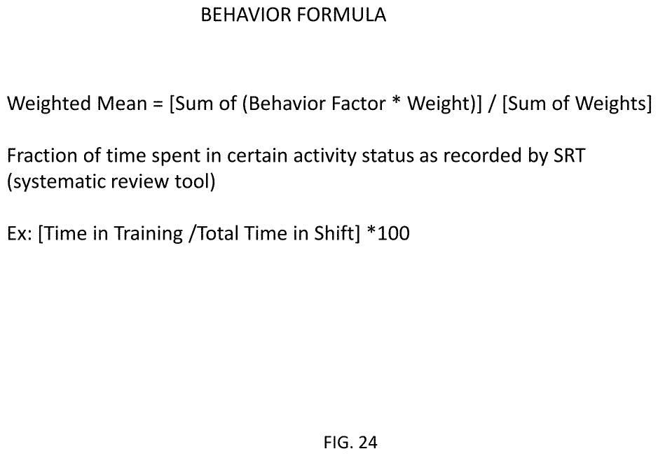

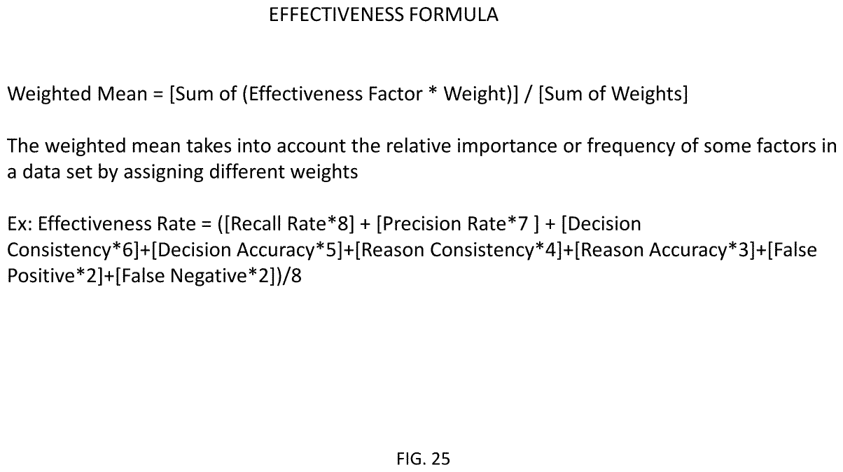

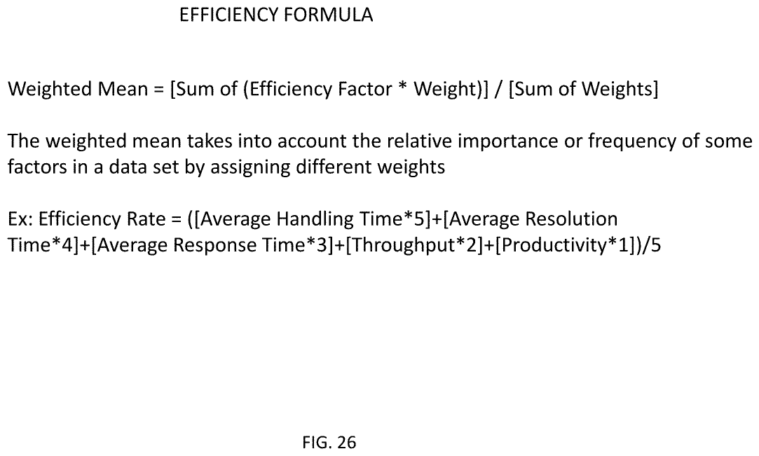

As mentioned above, approximately 300 to 400 factors may be considered/analyzed by the machine learning model, but the factors may be grouped into broader buckets. For example, FIG. 22 shows a table listing factors and subfactors for an organizational updates group, according to an embodiment. In this example, the factors, such as organizational changes, are the buckets into which the subfactors are grouped. In another example, FIG. 23 shows a table listing factors and subfactors for a performance group, according to an embodiment. FIG. 24 shows a behavior formula, according to an embodiment. The behavior formula may be applied to define aspects of the behavior factors. FIG. 25 shows an effectiveness formula, according to an embodiment. The effectiveness formula may be applied to define aspects of the effectiveness factors. FIG. 26 shows an efficiency formula, according to an embodiment. The efficiency formula may be applied to define aspects of the efficiency factors.

A user may select the option of isolating a particular characteristic or comparing smaller numbers of characteristics on the graphical representation to focus in on relationships between different characteristics with each other and/or with AHT over time. For example, a user may isolate tenure in the graphical representation and compare this with AHT. A user may readily see that a surge in AHT over the course of a few days correlates with a lower average tenure in the group of workers under analysis. If this view is a current representation of operational performance, the system may recommend a corrective action of putting more tenured workers on duty on the upcoming schedule. If this view is a prediction, rather than past data, the system may recommend a corrective action of putting more tenured workers on duty during the few days correlating with the surge in AHT. Either way, the system can present the recommended corrective action to the user on the display by itself or with other operational performance data. For example, in the latter case, the system may present to the user the recommended corrective action alongside the current or predicted decline in performance and/or the factors contributing to the current or predicted decline in performance.

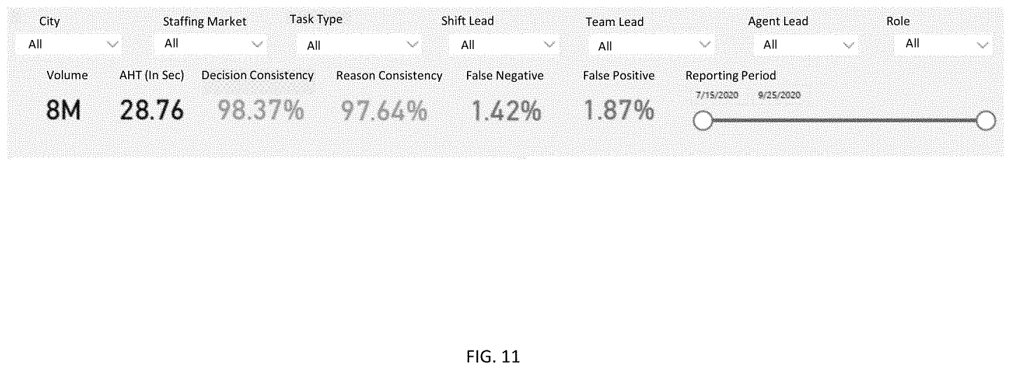

FIGS. 11-13 show screenshots of components of a dashboard on a graphical user interface, according to an embodiment. In FIG. 11, dropdown menus provide selections for city, staffing region, task type, shift lead, team lead, agent name, and role. A user may use these dropdown menus to select specific areas to appear in the display with associated metrics. In FIG. 11, the user may select a time period for which metrics may be provided for in the display. The screenshot in FIG. 11 displays the metrics of volume, AHT, decision consistency, reason consistency, false negative percentage, and false positive percentage for an entire workforce of an operation during a reporting period of Jul. 15, 2020 through Sep. 25, 2020.

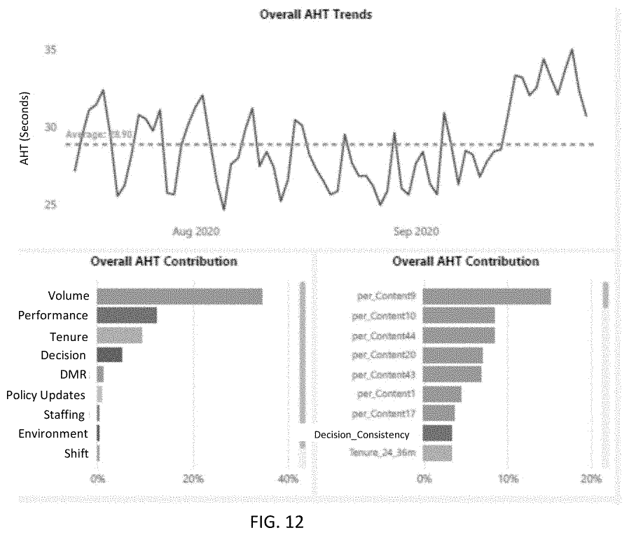

FIG. 12 shows information appearing on the display with the information of FIG. 11. The information in FIG. 12 includes a graph of overall AHT trends and a breakdown of the contribution each factor makes to impact the overall AHT trends.

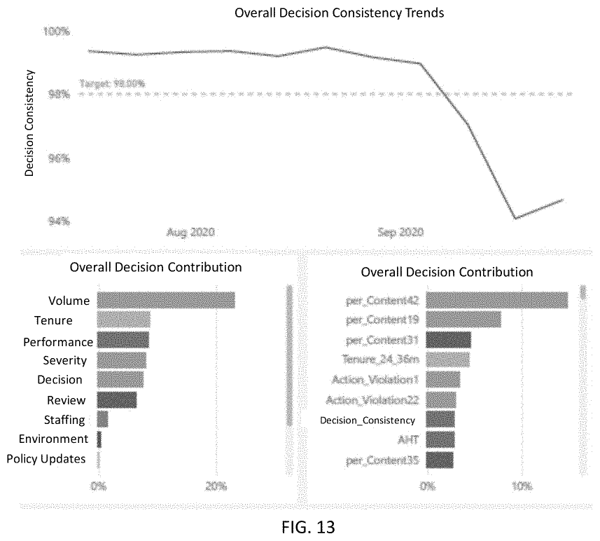

FIG. 13 shows information appearing on the display with the information of FIGS. 11 and 12. The information in FIG. 13 includes a graph of overall decision consistency trends and a breakdown of the contribution each factor makes to impact the overall decision consistency trends.

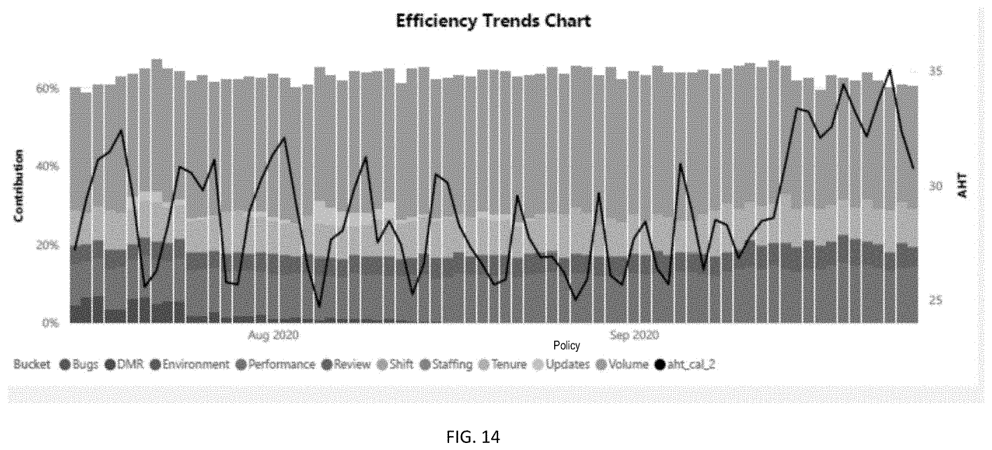

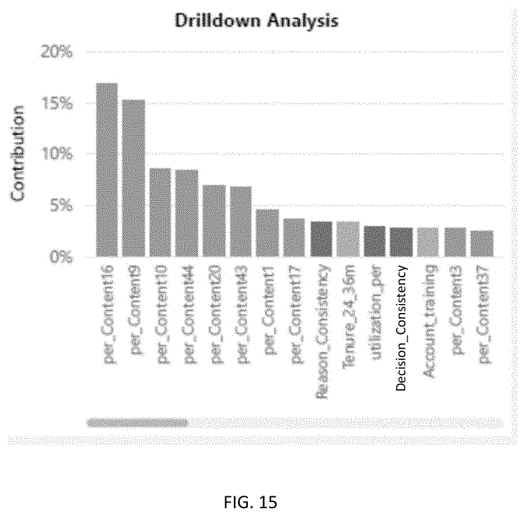

FIGS. 14-15 show screenshots of components of a dashboard on a graphical user interface, according to an embodiment. FIG. 13 shows efficiency trends for the time period of August 2020 through September 2020. The different colors on each bar represents the amount each factor listed at the bottom of the screen contributes to efficiency for each day during the time period. The black line shows the AHT during the same time period. FIG. 15 shows drilldown analysis including the contribution subfactor make toward the efficiency shown in FIG. 14.

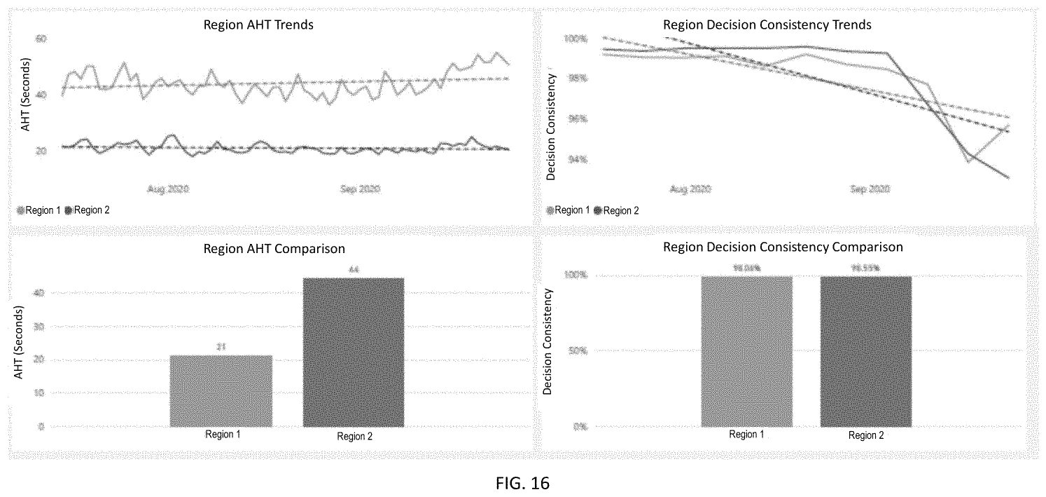

FIG. 16 show a screenshot of components of a dashboard on a graphical user interface, according to an embodiment. FIG. 16 shows graphical information about region AHT trends and region decision consistency trends during the time period of August 2020 through September 2020, as well as bar graphs demonstrating a comparison of region 1 and region 2 in both categories of AHT and decision consistency.

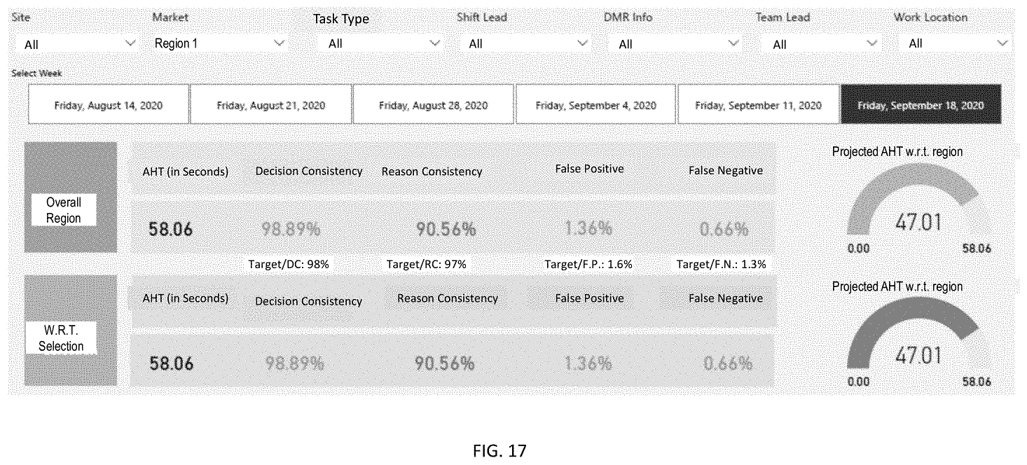

FIGS. 17-21 show screenshots of components of a dashboard on a graphical user interface, according to an embodiment. FIG. 17 shows dropdown menus provide selections for work site, region, task type, shift lead, DMR info, team lead, and work location. A user may use these dropdown menus to select specific areas to appear in the display with associated metrics. A user may also select from different weeks. In addition to showing current metrics in the overall region and with respect to a selection, this display shows projected AHT for each of the overall region and with respect to a selection.

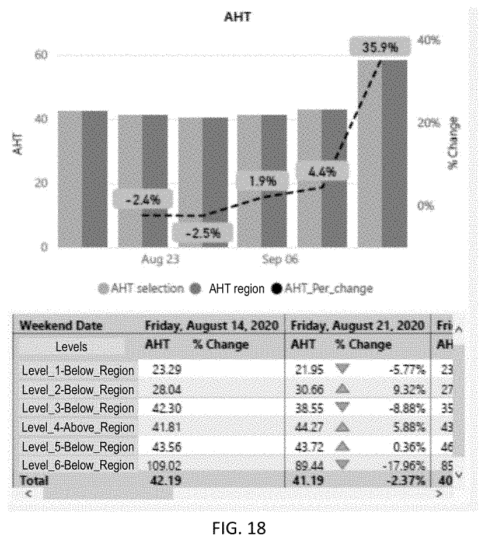

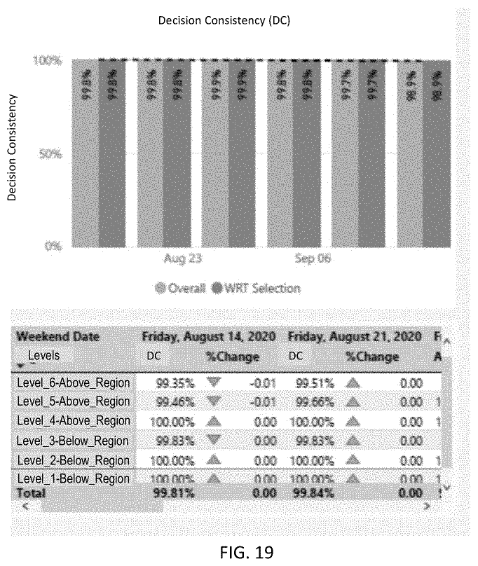

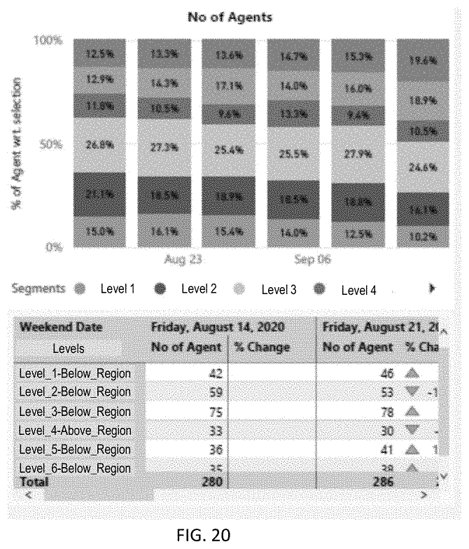

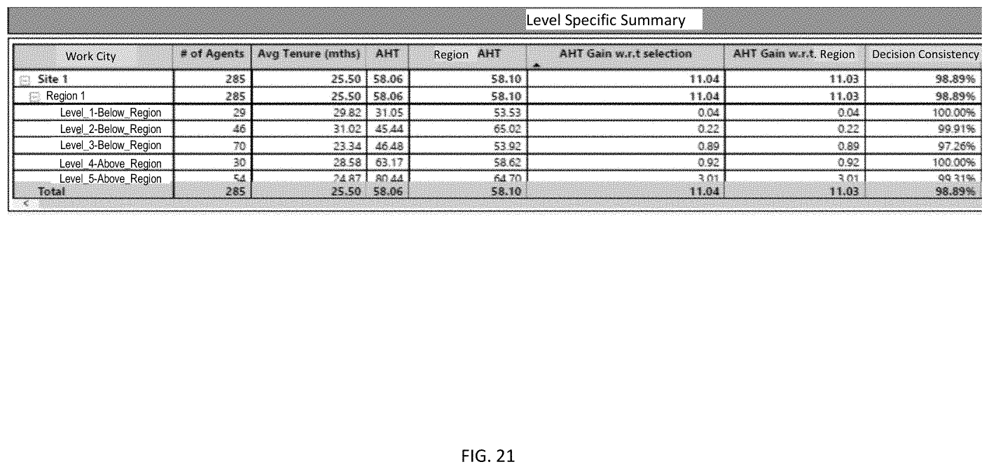

FIGS. 18-21 show information based on the selections made in FIG. 17. FIG. 18 shows information about the AHT of various levels and other information with respect to the region based for different weeklong time periods. FIG. 19 shows information about the decision consistency of various levels and other information with respect to the region based for different weeklong time periods. FIG. 20 shows information about the number of agents in various levels and other information with respect to the region based for different weeklong time periods. The same display in FIGS. 18-21 may display the options of focusing in on the metrics of each level (e.g., tier). FIG. 21 shows a screenshot of a component of a dashboard on a graphical user interface, according to an embodiment. FIG. 21 shows details in varying degree (e.g., site, region, levels, etc.) for city and corresponding metrics for number of agents, average tenure in months, average handling time, region AHT, AHT gain with respect to selection (e.g., selected level), AHT gain with respect to region, and decision consistency. Other metrics may include decision consistency, reason consistency, false negative percentage, and false positive percentage.

In some embodiments, the dashboard on the graphical user interface may include an option of showing a suggested corrective action with any of the tracked operational metrics discussed above, including predicted operational metrics. For example, the dashboard may show a predicted decline in operational metrics with the factors the system determines will contribute to the predicted decline and/or with the change in operational metrics resulting from taking the suggested corrective action and displaying the operational metrics resulting from taking the corrective action. In some embodiments, the disclosed method may include taking the corrective action.

In one example related to corrective actions, the dashboard may present a relatively high average handling time (e.g., 78 seconds) for a particular region or smaller group. In this example, the system may recommend a corrective action of assessing the overall effectiveness and efficiency KPIs according to certain filter selections to find out what factors and/or subfactors are impacting average handling time.

In yet another example related to corrective actions, referring to FIG. 12, the average handling time trends appear to increase with relatively high peaks toward the end of September 2020. In this example, the system may recommend a corrective action of performing drill-drown analysis on the days of the highest peaks to identify specific drivers (e.g., factors and/or subfactors making biggest impact) of average handling time and/or efficiency KPI.

In yet another example related to corrective actions, referring to FIG. 12, the dashboard may show factors, such as volume, contributing to the overall average handling time. The system may recommend a corrective action of investigating underlying work handling (e.g., volume) subfactors driving the average handling time trends across a selected reporting period to determine what changes may improve average handling time.

In yet another example related to corrective actions, the system may recommend a corrective action of performing a drill-down analysis on a particular day on which decision accuracy appears to be relatively low to identify specific drivers of decision accuracy and/or the effectiveness KPI

In some embodiments, the dashboard may show regional trends for average handling time by showing the average handling time over a selected period of time (e.g., days, months, years, etc.) for multiple regions. This visualization can help a user identify regions with the highest increase in average handling time according to the highest slope measure and prioritize corrective actions accordingly.

In some embodiments, the dashboard may show regional trends for decision accuracy by showing the decision accuracy over a selected period of time (e.g., days, months, years, etc.) for multiple regions. This visualization can help a user identify regions with the highest decrease in decision accuracy according to the lowest slope measure and prioritize corrective actions accordingly.

In some embodiments, the dashboard may show regional trends by showing the average handling time over a selected period of time (e.g., days, months, years, etc.) for multiple regions. This visualization can help a user identify regions with the highest increase in average handling time according to the highest slope measure and prioritize corrective actions accordingly.

In some embodiments, the dashboard may show heat maps for various regions (or subregions) according to various metrics. For example, several regions may be listed in an order according to highest average handling time and/or with color coding corresponding to average handling time.

In some embodiments, the dashboard may show a visualization of each factor's contribution to a particular metric (e.g., average handling time) over the course of a selected period of time (e.g., days, months, years, etc.). If this visualization shows that tenure/training factors being positively correlated with average handling time spikes or increases, then the system may recommend a corrective action of restaffing and/or training workers (e.g., agents) with the lowest tenure and hours spent in training.

In some embodiments, the dashboard may show a visualization of each subfactor's contribution to a particular metric (e.g., average handling time) over the course of a selected period of time (e.g., days, months, years, etc.). If this visualization shows that performance factors, such as decision accuracy, recall, reason accuracy, and utilization are positively correlated with average handling time spikes or increases, then the system may recommend a corrective action of improving and coaching workers on these performance factors.

In some embodiments, the dashboard may show a visualization of each worker's or team's average performance metric (e.g., average handling time) with respect to other workers or teams or may rank workers or teams by their average performance metric. These visualizations may be used to identify which workers or teams within a particular percentile. In some embodiments, the system may recommend a corrective action of performing a root cause analysis on the agents with an average performance metric falling in the 90th percentile or above.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

1. A computer implemented method for applying machine learning to monitor, analyze, and optimize operational procedures, comprising:
aggregating operational data from data sources, wherein the operational data includes at least operational performance data;
training a machine learning model to analyze the operational data to identify a decline in operational performance, map performance related factors to the decline in operational performance, and determine a corrective action corresponding to the decline in operational performance;
applying the machine learning model to analyze the operational data to identify a decline in operational performance, map performance related factors to the decline in operational performance, and determine a corrective action for counteracting the decline in operational performance; and
presenting, through a graphical user interface, an output comprising the operational performance data, the time period corresponding to the operational performance data, the mapped performance related factors, and the corrective action.

2. The method of claim 1, wherein aggregating operational data includes aggregating the operational data into an intelligent data foundation.

3. The method of claim 2, further comprising processing the aggregated operational data through the intelligent data foundation to generate standardized performance metrics, wherein applying the machine learning model to analyze the operational data includes analyzing the standardized performance metrics.

4. The method of claim 3, wherein the standardized performance metrics includes one or more of efficiency, effectiveness, and handling time.

5. The method of claim 4, further including applying machine learning to calculate performance related factors as output coefficients.

6. The method of claim 1, wherein the corrective action includes one or both of spending more time on training workers to improve efficiency and adjusting the schedule of workers to have a higher balance of tenured employees on duty during specific shifts.

7. The method of claim 1, further comprising:
receiving from a user through the graphical user interface input requesting display of performance related subfactors; and
using the input to update the graphical user interface to simultaneously display mapped performance related factors with performance related subfactors.

8. A system for applying machine learning to monitor, analyze, and optimize operational procedures, comprising:
one or more computers and one or more storage devices storing instructions that are operable, when executed by the one or more computers, to cause the one or more computers to:
aggregate operational data from data sources, wherein the operational data includes at least operational performance data;
train a machine learning model to analyze the operational data to predict a future decline in operational performance, map performance related factors to the predicted decline in operational performance, and determine a corrective action corresponding to the predicted decline in operational performance;
apply the machine learning model to analyze the operational data to predict a future decline in operational performance, map performance related factors to the predicted decline in operational performance, and determine a corrective action for counteracting the precited decline in operational performance; and
present, through a graphical user interface, an output comprising the operational performance data, the time period corresponding to the operational performance data, the mapped performance related factors, and the corrective action.

9. The system of claim 8, wherein aggregating operational data includes aggregating the operational data into an intelligent data foundation.

10. The system of claim 9, wherein the instructions further cause the one or more computers to process the aggregated operational data through the intelligent data foundation to generate standardized performance metrics, wherein applying the machine learning model to analyze the operational data includes analyzing the standardized performance metrics.

11. The system of claim 10, wherein the standardized performance metrics includes one or more of efficiency, effectiveness, and handling time.

12. The system of claim 8, wherein the factors include organizational processes.

13. The system of claim 8, wherein the corrective action includes one or both of spending more time on training workers to improve efficiency and adjusting the schedule of workers to have a higher balance of tenured employees on duty during specific shifts.

14. The system of claim 8, wherein the instructions further cause the one or more computers to:
receive from a user through the graphical user interface input requesting display of performance related subfactors; and
use the input to update the graphical user interface to simultaneously display mapped performance related factors with performance related subfactors.

15. A non-transitory computer-readable medium storing software comprising instructions executable by one or more computers which, upon such execution, cause the one or more computers to apply machine learning to monitor, analyze, and optimize operational procedures by:
aggregating operational data from data sources, wherein the operational data includes at least operational performance data;
training a machine learning model to analyze the operational data to predict a future decline in operational performance, map performance related factors to the predicted decline in operational performance, and determine a corrective action corresponding to the predicted decline in operational performance;
applying the machine learning model to analyze the operational data to predict a future decline in operational performance, map performance related factors to the predicted decline in operational performance, and determine a corrective action for counteracting the precited decline in operational performance; and
presenting, through a graphical user interface, an output comprising the operational performance data, the time period corresponding to the operational performance data, the mapped performance related factors, and the corrective action.

16. The non-transitory computer-readable medium of claim 15, wherein aggregating operational data includes aggregating the operational data into an intelligent data foundation.

17. The non-transitory computer-readable medium of claim 16, wherein the instructions further cause the one or more computers to process the aggregated operational data through the intelligent data foundation to generate standardized performance metrics, wherein applying the machine learning model to analyze the operational data includes analyzing the standardized performance metrics.

18. The non-transitory computer-readable medium of claim 17, wherein the standardized performance metrics includes one or more of efficiency, effectiveness, and handling time.

19. The non-transitory computer-readable medium of claim 15, wherein the factors include organizational processes.

20. The non-transitory computer-readable medium of claim 15, wherein the corrective action includes one or both of spending more time on training workers to improve efficiency and adjusting the schedule of workers to have a higher balance of tenured employees on duty during specific shifts.
